(19) United States
(12) Patent Application Publication
(10) Pub. No.: US 2026/0072255 A1
(43) Pub. Date: Mar. 12, 2026

(54) ANAMORPHIC LENS

(71) Applicant: Guangdong Sirui Optical Co., Ltd., Zhongshan (CN)

(72) Inventors: Jie Li, Zhongshan (CN); Kunyi Lin, Zhongshan (CN)

(73) Assignee: Guangdong Sirui Optical Co., Ltd., Zhongshan (CN)

(21) Appl. No.: 19/206,264

(22) Filed: May 13, 2025

(30) Foreign Application Priority Data
Sep. 12, 2024 (CN) 202411280555.6
Sep. 12, 2024 (CN) 202422247687.0

(51) Int. Cl. G02B 13/08; G02B 3/04; G02B 3/06; G02B 9/60

(52) U.S. Cl. CPC G02B 13/08; G02B 3/04; G02B 3/06; G02B 9/60

(57) ABSTRACT

An anamorphic lens, comprising a first spherical lens group, a first cylindrical lens group, a second spherical lens group, a second cylindrical lens group, and a third spherical lens group, which are sequentially arranged from the object side to the image side, and the focal lengths of all the lens groups satisfy the following conditional formulas: 1.1<f(1˜16) Y/f(1˜16)X<1.6; 1.6<f(3)X/f(1˜3)X<2.4; −8<f(4˜6)X/f(1˜16)X<−5.3; −12<f(10˜11)Y/f(9˜16)Y<−8; −3.5<f(12˜16)X/f(1˜16)X<−2.3. By combining the cylindrical lens group and the spherical lens group, the optical power may be reasonably distributed, making the lens compact and small; the spherical lens group corrects the light, and the cylindrical lens group compresses the horizontal light, so that the lens has high resolution, low breathing, low distortion and other performances.

### CROSS-REFERENCE TO RELATED APPLICATIONS

This application claims priority to Chinese applications 202411280555.6 and 20242224768.0, both filed on Sep. 12, 2024, whose disclosures are incorporated by reference in their entirety.

### TECHNICAL FIELD

Aspects of the invention generally relate to the technical field of optical lenses, and in particular to an anamorphic lens.

### BACKGROUND

With the rapid development of web technology, taking photos and videos has become essential part for ordinary consumers. With the promotion of 5G and other technologies in recent years, more and more video sharing such as Vlog has been used. More individuals shoot short films and micro movies with mobile phones, cameras and other tools.

However, the conventional shooting ratio of mobile phones, tablets, cameras and other devices on the market is 16:9, while the ratio of wide-screen videos with a cinematic feel is 2.4:1. At the same time, good micro-film or video shooting requires lenses of different focal lengths to cooperate with each other, especially close-ups of characters require medium-to-long focal length anamorphic lenses.

Existing anamorphic lenses have technical problems such as high price, large size and weight, large breathing effect and unstable magnification.

### SUMMARY

Therefore, the technical problem to be solved by embodiments of the present application may be to overcome the technical problems of expensive price, large volume and weight, large breathing effect and non-constant magnification of the anamorphic lens in the prior art, thereby providing an anamorphic lens.

To solve the above technical problems, the technical solution of embodiments of the present application may be as follows:
An anamorphic lens, comprising a first spherical lens group, a first cylindrical lens group, a second spherical lens group, a second cylindrical lens group, and a third spherical lens group arranged in sequence from the object side to the image side along the optical path;
The first spherical lens group comprises a first lens, a second lens and a third lens arranged in sequence from the object side to the image side along the optical path, the first lens may be a spherical lens with positive focal length, the second lens may be a spherical lens with negative focal length, and the third lens may be a spherical lens with negative focal length;
The first cylindrical lens group comprises a fourth lens, a fifth lens, and a sixth lens arranged in sequence from the object side to the image side along the optical path, the fourth lens and the fifth lens are both cylindrical lenses with negative focal length, and the sixth lens may be a cylindrical lens with positive focal length;
The second spherical lens group comprises a first lens, a second lens and a third lens arranged in sequence from the object side to the image side along the optical path; The seventh lens, the eighth lens, and the ninth lens are arranged in sequence, the seventh lens and the ninth lens are spherical lenses with positive focal length, and the eighth lens may be a spherical lens with negative focal length;
The second cylindrical lens group includes the tenth lens and the eleventh lens arranged in sequence from the object side to the image side along the optical path, the tenth lens may be a cylindrical lens with positive focal length, and the eleventh lens may be a cylindrical lens with negative focal length;
The third spherical lens group includes the twelfth lens, the thirteenth lens, the fourteenth lens, the fifteenth lens, and the sixteenth lens arranged in sequence from the object side to the image side along the optical path, the twelfth lens and the fourteenth lens are spherical lenses with negative focal length, the thirteenth lens and the fifteenth lens are spherical lenses with positive focal length, and the sixteenth lens may be a non-spherical lens with negative focal length;
The focal length distribution of the first lens to the sixteenth lens satisfies the following relationship:

$$1.1 < f ( 1 ∼ 16 ) Y / f ( 1 ∼ 16 ) X < 1.6 ;$$

$$1.6 < f ( 3 ) X / f ( 1 ∼ 3 ) X < 2.4 ;$$

$$- 8 < f ( 4 ∼ 6 ) X / f ( 1 ∼ 16 ) X < - 5.3 ;$$

$$- 12 < f ( 10 ∼ 11 ) Y / f ( 9 ∼ 16 ) Y < - 8 ;$$

$$- 3.5 < f ( 12 ∼ 16 ) X / f ( 1 ∼ 16 ) X < - 2.3 ;$$

Among them, the curvature direction of the fourth lens may be the X-axis, and the Y-axis may be the direction perpendicular to X; f(m˜n)Y may be the comprehensive optical focal length of the mth lens to the nth lens along the Y-axis, and f(m˜n)X may be the comprehensive optical focal length of the mth lens to the nth lens along the X-axis, and m and n are both positive integers, 1≤m<n≤16.

Further, the third lens moves forward and backward to achieve internal focusing.

Further, the twelfth lens and the thirteenth lens are glued to each other to form a double-glued spherical lens; the fourteenth lens and the fifteenth lens are glued to each other to form a double-glued spherical lens. The double-glued spherical lens may be used to correct the optical chromatic aberration of the large-magnification anamorphic lens in the horizontal and vertical directions.

Further, the fifth lens and the sixth lens are glued to each other to form a double-glued cylindrical lens; the tenth lens and the eleventh lens are glued to each other to form a double-glued cylindrical lens.

Further, the comprehensive optical focal length of the anamorphic lens in the Y-axis may be within the range of 30˜50 mm.

Further, the zoom ratio range of the anamorphic lens may be 1.25×˜1.4×, and the magnification ratio at different object distances remains constant.

Further, the total optical length of the anamorphic lens does not exceed 150 mm.

Further, the aperture of the anamorphic lens does not exceed 2.

Further, the first lens, the second lens, the third lens, the fourth lens, the fifth lens, the sixth lens, the seventh lens, the eighth lens, the ninth lens, the tenth lens, the eleventh lens, the twelfth lens, the thirteenth lens, the fourteenth lens and the fifteenth lens are all optical glass lenses, and the sixteenth lens may be an aspherical glass lens.

The technical solution of this application has the following advantages: by combining the X-direction cylindrical lens group and the spherical lens group, the optical focal length may be reasonably distributed, so that the optical structure of the anamorphic lens may be more compact and compact, and the cost may be lower, and the light may be comprehensively corrected by the spherical lens group, and then the optical characteristics of the cylindrical lens group are used to “compress” the light entering horizontally, while the light entering vertically remains unchanged, thereby increasing the field of view of the lens for horizontal shooting and ensuring the performance in the X-axis. The Y-direction cylindrical lens group and spherical lens group stabilize the performance in the other direction. In this way, the half-frame and large magnification of the lens are achieved. In addition, the compact design of the integrated cylindrical lens and spherical lens makes the lens small in size and light in weight, greatly reducing the cost. The aspherical lens may effectively correct the spherical aberration and astigmatism of the lens, improving the lens resolution while reducing the size and weight of the lens.

### BRIEF DESCRIPTION OF THE DRAWINGS

In order to more clearly illustrate the specific embodiments of the present invention or the technical solutions in the prior art, the drawings needed to be used in embodiments or the description of the prior art are briefly introduced below. Obviously, the drawings in the following are some embodiments of the present invention. For those of ordinary skill in the art, other drawings may be obtained based on these drawings without undue creative labor.

FIG. 1 is an optical structure diagram of an anamorphic lens in the X-axis when an object-image distance is infinite in one embodiment of the present invention;

FIG. 2 is an optical structure diagram of the anamorphic lens in the Y-axis when the object-image distance is infinite in one embodiment of the present invention;

FIG. 3 is an optical field curvature and distortion diagram of the anamorphic lens in one embodiment of the present invention when the object-image distance is infinite;

FIG. 4 is an optical structure diagram of the anamorphic lens in the X-axis when the object-image distance is 0.5m in one embodiment of the present invention;

FIG. 5 is an optical structure diagram of the anamorphic lens in the Y-axis when the object-image distance is 0.5m in one embodiment of the present invention;

FIG. 6 is an optical field curvature and distortion diagram of the anamorphic lens in one embodiment of the present invention when the object-image distance is 0.5m.

Reference numbers' list: 100: a first spherical lens group; 200: a first cylindrical lens group; 300: a second spherical lens group; 400: a second cylindrical lens group; 500: a third spherical lens group; 1: a first lens; 2: a second lens; 3: a third lens; 4: a fourth lens; 5: a fifth lens; 6: a sixth lens; 7: a seventh lens; 8: an eighth lens; 9: a ninth lens; 10: a tenth lens; 11: an eleventh lens; 12: a twelfth lens; 13: a thirteenth lens; 14: a fourteenth lens; 15: a fifteenth lens; 16: a sixteenth lens.

### DETAILED DESCRIPTION

The technical solution of the present invention may be clearly and completely described below with reference to the accompanying drawings. Obviously, the described embodiments may be part of the present invention, but not all of them. Based on the embodiments of the present invention, all other embodiments obtained by a person of ordinary skill in the art without creative efforts shall fall within the protection scope of the present invention.

In the description of the present invention, it is noted that the terms “center”, “up”, “down”, “left”, “right”, “vertical”, “horizontal”, “inside”, “outside”, etc., are meant to indicate orientation or positional relationship and they may be based on the orientation or positional relationship shown in the drawings, and may only be for the convenience of describing the present invention and simplified description, and does not indicate or imply that the device or element referred to must have a specific orientation, a specific construction and operation as they are not be construed as limiting the invention. In addition, the terms “first,” “second,” and “third” may be used for descriptive purposes only, and should not be construed to indicate or imply relative importance.

In the description of embodiments of the present invention, it is noted that the terms “installation”, “connected”, and “connected” should be understood in a broad sense unless otherwise specified and limited. For example, they may be fixed connections or removable, connected or integrated; it may be mechanical or electrical; it may be directly connected, or it may be indirectly connected through an intermediate medium, or it may be the internal communication of two elements. For those of ordinary skill in the art, the specific meanings of the above terms of embodiments of the present invention may be understood in a case-by-case basis.

In addition, the technical features involved in the different embodiments of the present invention described below may be combined with each other as long as they do not conflict with each other.

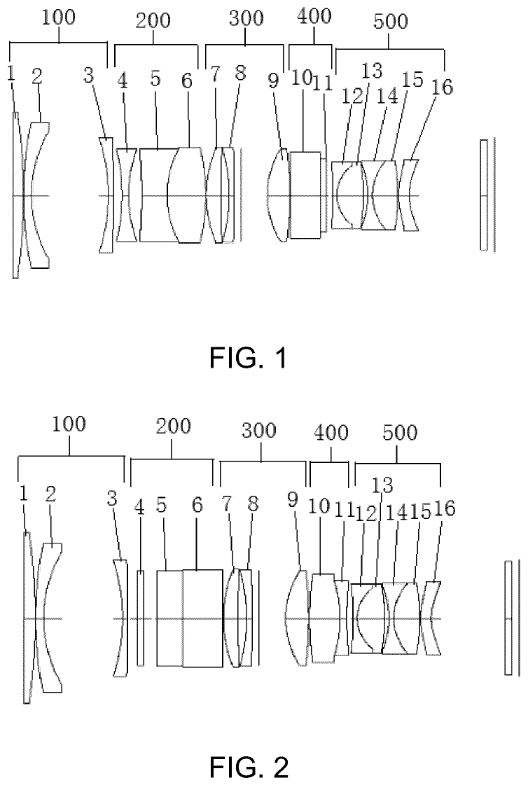

Referring now to FIGS. 1-6, an anamorphic lens according to aspects of the invention may include a first spherical lens group 100, a first cylindrical lens group 200, a second spherical lens group 300, a second cylindrical lens group 400 and a third spherical lens group 500 arranged in sequence along the optical path from the object side to the image side.

Among them, the first spherical lens group 100 includes a first lens 1, a second lens 2 and a third lens 3 arranged in sequence along the optical path from the object side to the image side, the first lens 1 may be a spherical lens with positive focal length, the second lens 2 may be a spherical lens with negative focal length, and the third lens 3 may be a spherical lens with negative focal length.

The first cylindrical lens group 200 includes a fourth lens 4, a fifth lens 5 and a sixth lens 6 arranged in sequence along the optical path from the object side to the image side, the fourth lens 4 and the fifth lens 5 are both cylindrical lenses with negative focal length, and the sixth lens 6 may be a cylindrical lens with positive focal length.

The second spherical lens group 300 includes a seventh lens 7, an eighth lens 8, and a ninth lens 9 arranged in sequence along the optical path from the object side to the image side. The seventh lens 7 and the ninth lens 9 are both spherical lenses with positive focal length, and the eighth lens 8 may be a spherical lens with negative focal length.

The second cylindrical lens group 400 includes a tenth lens 10 and an eleventh lens 11 arranged in sequence along the optical path from the object side to the image side. The tenth lens 10 may be a cylindrical lens with positive focal length, and the eleventh lens 11 may be a cylindrical lens with negative focal length.

The third spherical lens group 500 includes a twelfth lens 12, a thirteenth lens 13, a fourteenth lens 14, a fifteenth lens 15, and a sixteenth lens 16 arranged in sequence along the optical path from the object side to the image side. The twelfth lens 12 and the fourteenth lens 14 are both spherical lenses with negative focal length, the thirteenth lens 13 and the fifteenth lens 15 are both spherical lenses with positive focal length, and the sixteenth lens 16 may be an aspherical lens with negative focal length.

The focal length distribution of the first lens 1 to the sixteenth lens 16 satisfies the following relationship:

$$1.1 < f ( 1 ∼ 16 ) Y / f ( 1 ∼ 16 ) X < 1.6 ;$$

$$1.6 < f ( 3 ) X / f ( 1 ∼ 3 ) X < 2.4 ;$$

$$- 8 < f ( 4 ∼ 6 ) X / f ( 1 ∼ 16 ) X < - 5.3 ;$$

$$- 12 < f ( 10 ∼ 11 ) Y / f ( 9 ∼ 16 ) Y < - 8 ;$$

$$- 3.5 < f ( 12 ∼ 16 ) X / f ( 1 ∼ 16 ) X < - 2.3 ;$$

Among them, the curvature direction of the fourth lens may be the X-axis, and the Y-axis may be the direction perpendicular to X; f(m˜n)Y may be the comprehensive optical focal length of the mth lens to the nth lens along the Y-axis, and f(m˜n)X may be the comprehensive optical focal length of the mth lens to the nth lens along the X-axis. Both m and n are positive integers, and 1≤m<n≤16.

This anamorphic lens may be used in combination with the X-direction cylindrical lens group and the spherical lens group to reasonably distribute the focal length, making the optical structure of the anamorphic lens more compact and compact, and lower in cost. The spherical lens group may be used to comprehensively correct the light, and then the optical characteristics of the cylindrical lens group are used to “compress” the light entering horizontally, while the light entering in the vertical direction remains unchanged, thereby increasing the field of view of the lens for horizontal shooting and ensuring the performance in the X-axis. The Y-direction cylindrical lens group and the spherical lens group are used to stabilize the performance in the other direction. In this way, the half-frame and large magnification of the lens are achieved. In addition, the compact design of the integrated cylindrical lens and spherical lens makes the lens small in size, light in weight, and greatly reduces the cost. The aspherical lens may effectively correct the spherical aberration and astigmatism of the lens, improve the lens resolution and reduce the lens size and weight.

In this embodiment, the comprehensive optical focal length of the anamorphic lens in the Y-axis may be in the range of 30˜50 mm. The zoom ratio of the anamorphic lens may be in the range of 1.25×˜1.4×, and the magnification at different object distances remains constant. The total optical length of the anamorphic lens does not exceed 150 mm. The aperture of the anamorphic lens does not exceed 2.

In this embodiment, the third lens 3 moves forward and backward to achieve internal focusing. The overall length of the lens remains unchanged during adjustment, and the focus of the object-image distance from 0.65m to infinity may be achieved by moving the third lens 3 forward and backward, while overcoming the technical difficulties of the large breathing effect and the non-constant magnification of the anamorphic lens.

In this embodiment, the twelfth lens 12 and the thirteenth lens 13 are glued to each other to form a double-glued spherical lens. The fourteenth lens 14 and the fifteenth lens 15 are glued together to form a double-glued spherical lens. The fifth lens 5 and the sixth lens 6 are glued together to form a double-glued cylindrical lens. The tenth lens 10 and the eleventh lens 11 are glued together to form a double-glued cylindrical lens. The double-glued spherical lens may be used to correct the optical chromatic aberration of the deformed lens in the horizontal and vertical directions.

It should be pointed out that the above-mentioned multiple groups of double-glued spherical lenses are combined by bonding. As an alternative embodiment, such as bonding, integral molding and other combination methods, and then the shape of the combined lens may be adaptively changed, which may be understood by aspects of the invention. For a single lens or two consecutive lenses with the same optical power, the single lens may be split into two or more lenses, and two consecutive lenses with the same optical power may be combined into one lens. Such simple transformations of the optical structure of the patent, such as the distribution of the optical power of the transformed lens or lens group may be within the scope of the mathematical relationship expression of the patent. On the basis of this embodiment, the number and combination of lenses are changed and replaced to distinguish from this application, without departing from the main idea of this application, and they all belong to the protection scope of this application.

In this embodiment, the first lens 1, the second lens 2, the third lens 3, the fourth lens 4, the fifth lens 5, the sixth lens 6, the seventh lens 7, the eighth lens 8, the ninth lens 9, the tenth lens 10, the eleventh lens 11, the twelfth lens 12, the thirteenth lens 13, the fourteenth lens 14 and the fifteenth lens 15 are all optical glass lenses, and the sixteenth lens 16 may be an aspherical glass lens.

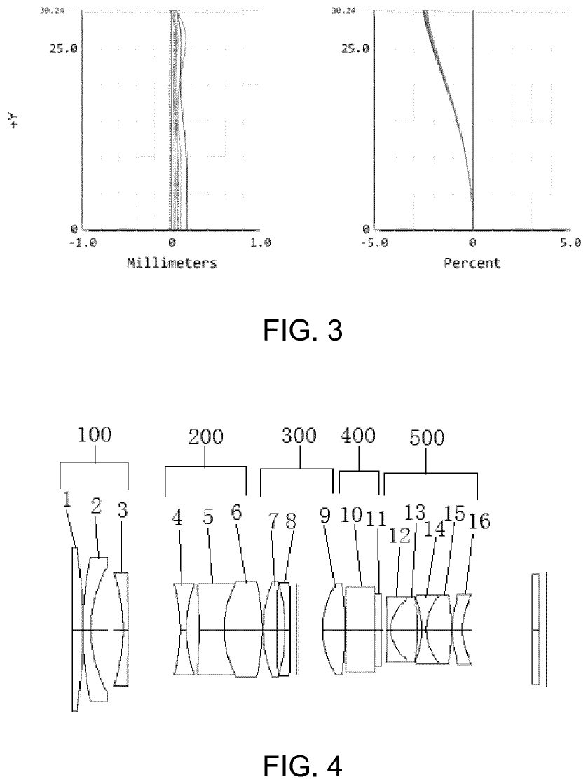

FIG. 3 is a field curvature diagram and a distortion diagram of the anamorphic lens according to one embodiment. It may be seen from the curve in the figure that the field curvature may be basically less than +0.2, ensuring that the large field of view has the same clarity; the distortion may be less than 5%, ensuring that the imaging screen has a smaller deformation.

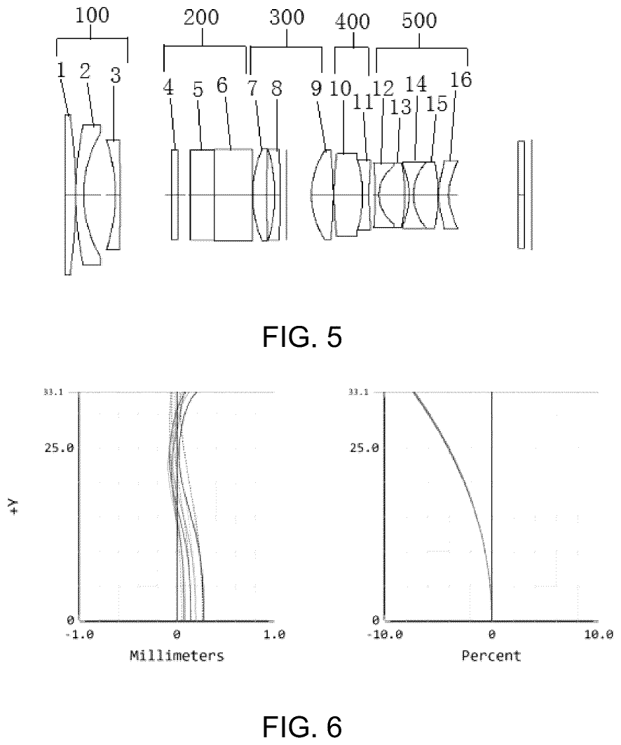

Referring to FIGS. 4-5, the third lens 3 may be adjusted in the anamorphic lens, and the overall length of the anamorphic lens remains unchanged, so that the ultra-close object-image distance of the anamorphic lens may be 0.5m. See FIG. 6, which shows the field curvature and distortion diagram of the anamorphic lens at close object distance. From the curves in the figure, it may be seen that the field curvature may be basically less than +0.5, ensuring that the image has the same clarity in a large field of view; the distortion may be less than 10%, ensuring that the image has a small deformation.

Table 1 below lists the actual parameters of each lens of this embodiment that conform to the above mathematical relationship:

TABLE 1

| | | X radius | Y radius | Thickness | Refractive | Abbe |
|---|---|---|---|---|---|---|
| Lens | Shape | (mm) | (mm) | (mm) | Index | Number |
| First lens | Spherical | Infinity | Infinity | 3.72 | 1.625 | 61.66 |
| | Spherical | −219.761 | −219.761 | 0.10 | | |
| Second lens | Spherical | 134.985 | 134.985 | 2.44 | 1.658 | 47.42 |
| | Spherical | 44.025 | 44.025 | 21.48 | | |
| Third lens | Spherical | −63.935 | −63.935 | 1.48 | 1.499 | 65.00 |
| | Spherical | −750.629 | −750.629 | 2.48 | | |
| Fourth lens | Spherical | −79.604 | inf | 1.96 | 1.666 | 50.61 |
| | Spherical | 46.537 | inf | 4.86 | | |
| Fifth lens | Spherical | −216.925 | inf | 6.21 | 1.605 | 32.15 |
| Sixth lens | Spherical | 35.768 | inf | 10.91 | 1.830 | 33.72 |
| | Spherical | −76.901 | inf | 0.12 | | |
| Seventh lens | Spherical | 47.356 | 47.356 | 3.86 | 1.921 | 27.50 |
| | Spherical | 496.209 | 496.209 | 1.97 | | |
| Eighth lens | Spherical | −53.131 | −53.131 | 1.63 | 1.688 | 47.69 |
| | Spherical | −260.724 | −260.724 | 1.82 | | |
| Aperture | Spherical | inf | inf | 7.93 | | |
| Ninth lens | Spherical | 25.443 | 25.443 | 6.31 | 1.721 | 43.53 |
| | Spherical | −143.432 | −143.432 | 0.21 | | |
| Tenth lens | Cylindrical | inf | 117.465 | 8.50 | 1.801 | 35.08 |
| Eleventh lens | Cylindrical | inf | −40.214 | 1.78 | 1.915 | 32.60 |
| | Cylindrical | inf | 104.198 | 1.83 | | |
| Twelfth lens | Spherical | −112.946 | −112.946 | 0.99 | 1.757 | 22.63 |
| Thirteen lens | Spherical | 12.196 | 12.196 | 7.77 | 1.713 | 54.11 |
| | Spherical | −62.112 | −62.112 | 1.11 | | |
| Fourteenth lens | Spherical | −33.065 | −33.065 | 1.30 | 1.644 | 30.88 |
| Fifteenth lens | Spherical | 16.641 | 16.641 | 7.27 | 1.829 | 19.86 |
| | Spherical | −60.495 | −60.495 | 0.18 | | |
| Sixteenth lens | Aspherical | 24.230 | 24.230 | 3.06 | 1.753 | 48.77 |
| | Aspherical | 19.263 | 19.263 | 18.43 | | |
| | Spherical | inf | inf | 2.00 | 1.517 | 64.20 |
| | Spherical | inf | inf | 2.06 | | |

The aspheric coefficients of the sixteenth lens 16 are as shown in Table 2:

TABLE 2

| Sixteenth lens | Face 1 | Face 2 |
|---|---|---|
| K | −2.418 | 0.348988415 |
| A4 | −4.19176E−05 | −2.78851E−05 |
| A6 | −4.3866E−07 | −8.69932E−07 |
| A8 | 2.57686E−10 | 1.72388E−09 |

The anamorphic lens provided by aspects of the invention may adopt an integrated design to achieve high resolution, low breathing, low distortion, half-frame, 1.25×˜1.4× high magnification and other excellent cost-effective optical performance while achieving a small lens size. It may be designed to be compatible with the bayonet mounts of various brands of cameras on the market according to actual use requirements to achieve personalized customization and universal cooperation.

Obviously, the above embodiments are only examples for clear explanation, and are not limitations on the implementation methods. For ordinary technicians in the field, other different forms of changes or modifications may be made on the basis of the above description. It is not necessary and impossible to list all the implementation methods here. The obvious changes or modifications derived from this are still within the scope of protection created by this application.

What is claimed is:

1. An anamorphic lens comprising:
a first spherical lens group;
a first cylindrical lens group;
a second spherical lens group;
a second cylindrical lens group; and
a third spherical lens group (500) arranged in sequence along an optical path from an object side to an image side;
wherein the first spherical lens group comprises a first lens, a second lens, and a third lens arranged in sequence along the optical path from the object side to the image side;
wherein the first lens comprises a spherical lens with a positive optical power; wherein the second lens comprises a spherical lens with a negative focal length;
wherein the third lens comprises a spherical lens with a negative focal length;
wherein the first cylindrical lens group comprises a fourth lens, a fifth lens, and a sixth lens arranged in sequence from the object side to the image side along the optical path;
wherein the fourth lens and the fifth lens comprise both cylindrical lenses with negative focal length;
wherein the sixth lens comprises a cylindrical lens with positive focal length;
wherein the second spherical lens group comprises a seventh lens, an eighth lens, and a spherical lens arranged in sequence from the object side to the image side along the optical path;
wherein the seventh lens and the ninth lens comprise both spherical lenses with positive focal length, and the eighth lens comprises a spherical lens with negative focal length;
wherein the second cylindrical lens group includes a tenth lens and an eleventh lens arranged in sequence along the optical path from the object side to the image side;
wherein the tenth lens comprises a cylindrical lens with positive focal length;
wherein the eleventh lens comprises a cylindrical lens with negative focal length;
wherein the third spherical lens group comprises a twelfth lens, a thirteenth lens, a fourteenth lens, a fifteenth lens, and a sixteenth lens arranged in sequence from the first lens to the image side;
wherein the twelfth lens and the fourteenth lens comprise both spherical lenses with negative focal length;
wherein the thirteenth lens and the fifteenth lens comprise both spherical lenses with positive focal length;
wherein the sixteenth lens comprises an aspherical lens with negative focal length; and
a focal length distribution of the first lens to the sixteenth lens comprises the following relationship:
$$1.1 < f ( 1 ∼ 16 ) Y / f ( 1 ∼ 16 ) X < 1.6 ;$$
$$1.6 < f ( 3 ) X / f ( 1 ∼ 3 ) X < 2.4 ;$$
$$- 8 < f ( 4 ∼ 6 ) X / f ( 1 ∼ 16 ) X < - 5.3 ;$$
$$- 12 < f ( 10 ∼ 11 ) Y / f ( 9 ∼ 16 ) Y < - 8 ;$$
$$- 3.5 < f ( 12 ∼ 16 ) X / f ( 1 ∼ 16 ) X < - 2.3 ;$$
wherein a curvature direction of the fourth lens (4) comprises a X-axis, and the Y-axis comprises a direction perpendicular to the X-axis; f(m˜n)Y is the comprehensive optical focal length from the mth lens to the nth lens along the Y-axis, and f(m˜n)X is the comprehensive optical focal length from the mth lens to the nth lens along the X-axis, and m and n are both positive integers, 1≤m<n≤16.

2. The anamorphic lens according to claim 1, wherein the third lens is configured to move forward and backward to achieve internal focusing.

3. The anamorphic lens according to claim 1, wherein the twelfth lens and the thirteenth lens are configured to glue together to form a double-cemented spherical lens; wherein the fourteenth lens and the fifteenth lens are configured to glue together to form a double-cemented spherical lens.

4. The anamorphic lens according to claim 1, wherein the fifth lens and the sixth lens are configured to glue together to form a double-cemented cylindrical lens;
wherein the tenth lens and the eleventh lens are configured to glue together to form a double-cemented cylindrical lens.

5. The anamorphic lens according to claim 1, wherein the comprehensive optical focal length of the anamorphic lens in the Y-axis is configured to be within the range of 30˜50 mm.

6. The anamorphic lens according to claim 1, wherein a zoom ratio range of the anamorphic lens is configured to be 1.25 to 1.4 times, and a magnification ratio remains constant at different object distances.

7. The anamorphic lens according to claim 1, wherein the total optical length of the anamorphic lens not exceeding 150 mm.

8. The anamorphic lens according to claim 1, wherein the aperture of the anamorphic lens not exceeding 2.

9. The anamorphic lens according to claim 1, wherein the first lens, the second lens, the third lens, the fourth lens, the fifth lens, the sixth lens, the seventh lens, the eighth lens, the ninth lens, the tenth lens, the eleventh lens, the twelfth lens, the thirteenth lens, the fourteenth lens and the fifteenth lens comprise all optical glass lenses, and the sixteenth lens comprises an aspherical glass lens.
